(19) United States
(12) Patent Application Publication
(10) Pub. No.: US 2004/0233803 A1
(43) Pub. Date: Nov. 25, 2004

(54) Information recording method and recording apparatus

(75) Inventors: Osamu Kawamae, Yokohama (JP); Taku Hoshizawa, Kawasaki (JP)

Correspondence Address: McDermott, Will & Emery, 600, 13th Street, N.W., Washington, DC, 20005-3096, US

(73) Assignees: Hitachi, Ltd.; Hitachi-LG Data Storage, Inc.

(21) Appl. No.: 10/695,795

(22) Filed: Oct. 30, 2003

(30) Foreign Application Priority Data
May 19, 2003 (JP) 2003-139756
Jul. 4, 2003 (JP) 2003-191590

(51) Int. Cl. G11B 7/0045

(52) U.S. Cl. 369/47.3; 369/47.31

(57) ABSTRACT

Conventionally, in a write-once-read-many recording medium, management of recorded/unrecorded areas is required. However, it takes much time to check recorded areas on the whole disk area, and further, the delay of processing is not considered. To solve these problems, information of recorded/unrecorded area management is recorded as a table on a disk, and the table information is regulated so that management information can be efficiently stored. Further, it can be determined whether or not the latest management information is recorded on the disk by using a flag indicating whether or not the table data has been recorded on the disk.

### BACKGROUND OF THE INVENTION

1. Field of the Invention

The present invention relates to a method for managing recorded/unrecorded area of data on a recordable optical disk.

2. Description of the Related Art

Optical disks are widely used as data recording media. Particularly, so-called write-once-read-many optical recording disks such as a CD-R and a DVD-R are used for data storage.

In this write-once-read-many disk in which writing can be made only once, recorded/unrecorded area management is important for the below reason. Generally, the write-once-read-many disk is so designed as to employ an organic coloring matter as its recording film. In the write-once-read-many disk, information reading is performed such that: upon laser irradiation, heat is generated by absorbed light thereby plastic deformation of substrate is caused in a portion irradiated with laser light; as a result, the reflectivity of the deformed portion becomes lower than an undeformed portion; the information reading is made by using the difference of reflectivity. In the write-once-read-many disk on which recording can be made once, once the substrate is deformed by recording, it cannot be fixed again, thus management of recorded area and unrecorded area is important.

In accordance with increment in the capacity of optical disk, a recordable data amount is increased. In particular, optical disks specified for a personal computer has various sizes of files to be treated. Consequently, the recording area management is further complicated. JP-A No. 119127/1994 (pages 2 and 3, FIGS. 1 and 2) discloses a solution of the problem.

### SUMMARY OF THE INVENTION

The feature of the optical disk is random accessibility. Even if a regulation, e.g. to perform recording from an inner circumferential area, is not set, any area on the disk can be accessed at random and recording can be made.

In the optical disk, its area management table should be required to be well structured because: when the disk capacity is increased, a huge number of areas must be managed, leading to a large capacity required for the management table; especially in a write-once recording medium, the consumption of management area is a problem; further as management information is important, high reliability is required; and the table structure for area management has an influence on reading speed and reliability. The JP-A No. 119127/1994, however, does not disclose any particular structure of area management table.

Under the circumstances, the present invention aims at providing an information recording method for recording data on a write-once-read-many recording medium thereby to solve the above-mentioned problems.

One aspect of the invention resides in an information recording method in which information corresponding to a recorded area position of the recording medium is recorded on the recording medium, and information is newly recorded on the recording medium at predetermined timing.

Another aspect of the invention resides in a recording apparatus, having a pickup, a signal processing circuit to perform signal processing accompanying recording and an interface for data input/output, for recording data on a write-once-read-many recording medium, wherein the recording apparatus is configured such that: information corresponding to a recorded area position of the recording medium is read from the recording medium and stored onto a nonvolatile memory; and that if the information corresponding to the recorded area position is updated, an update flag is set in the nonvolatile memory, the information corresponding to the recorded area position is recorded on the recording medium at predetermined timing, and the update flag is reset upon completion of recording.

Further, upon recording, as a recording flag indicating a recording direction is added, in scanning of recorded/unrecorded areas of the recording medium, the direction of recording can be detected and an unrecorded area can be detected.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 illustrates a status where recording is made in recording areas (n−2), (n−1) and (n) and a management table, according to an embodiment of the present invention;

FIG. 2 illustrates recorded/unrecorded areas and the contents of the management table, according to the embodiment;

FIG. 3 illustrates a status where recording is newly made in an area 4-in-a-circle in addition to areas 1-in-a-circle to 3-in-a-circle in FIG. 2;

FIG. 4 illustrates a status where recording is newly made in an area (k) in addition to areas (m) and (m+1);

FIG. 5 illustrates a status where recording is newly made in an area (j) in addition to the areas (m) and (m+1);

FIG. 6 illustrates a status where recording is newly made in an area (j+1) in addition to the areas (m), (j) and (m+1);

FIG. 7 is a block diagram showing an example of the construction of a system for recording and reproducing data on/from a disk;

FIG. 8 illustrates an example where a data recording area and a recorded/unrecorded area management table are recorded on a write-once-read-many optical disk;

FIG. 9 is a flowchart showing processing upon update of the contents of the recorded/unrecorded area management table;

FIG. 10 illustrates an example where identification information is added by overwriting the information on a recorded data on a disk;

FIG. 11 illustrates a block structure of recorded data described in “Optical Disc System for Digital Video Recording” (Jpn. J. Appl. Phys. Vol. 39(2000) Pt. 1, No. 2B FIG. 2);

FIG. 12 illustrates the structure of LDC code in FIG. 11;

FIG. 13 illustrates an example where particular burst errors are generated by overwriting in the recorded data block structure in FIG. 11;

FIG. 14 illustrates the burst errors in FIG. 13 in the structure of LDC code in FIG. 12;

FIG. 15 illustrates a status where a gap remains as a result of recording in a previous recorded area and a subsequent recorded area;

FIG. 16 illustrates an example of the flow of processing to encode recording data;

FIG. 17 illustrates an example where a signal for recording direction identification is included in a part of identification data;

FIG. 18 illustrates an example where a signal for recording direction identification is included in a part of synchronizing data;

FIG. 19 is a flowchart showing an example of the flow of processing to set a recording direction flag upon data recording;

FIG. 20 illustrates the types of location of new recorded area with respect to a previous recorded area when data is newly recorded;

FIG. 21 illustrates an example where an unrecorded area remains upon data recording;

FIG. 22 illustrates an example of setting of a direction flag upon new data recording; and

FIG. 23 is an example of the management table_according to another embodiment of the present invention.

### DETAILED DESCRIPTION OF THE PREFERRED EMBODIMENT

Hereinbelow, a preferred embodiment of the present invention will be described in accordance with the drawings.

Reference numerals used in the drawings are as follows.

701 . . . host side I/F, 702 . . . data recording/reproduction apparatus, 703 . . . input/output I/F, 704 . . . signal processing circuit, 705 . . . signal processing buffer, 706 . . . optical disk, 707 . . . system controller, and 708 . . . nonvolatile memory.

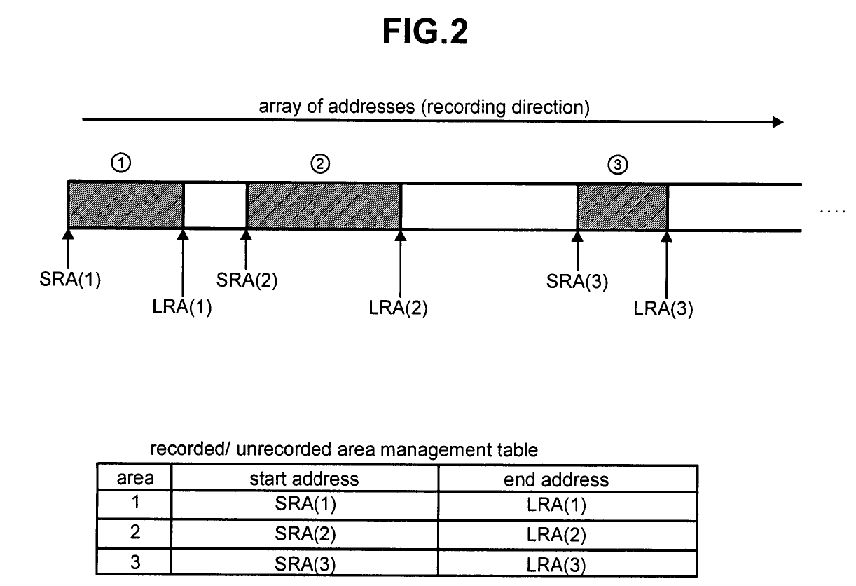

FIG. 2 illustrates recorded/unrecorded areas and the contents of a management table thereof according to an embodiment of the present invention. The figure shows recording areas on the disk among which hatched areas 1-in-a-circle to 3-in-a-circle are recorded area where printing has been made. In this example, the address number assigned on the disk increases from the left side to the right side of the figure, and upon data writing, recording proceeds along an arrow direction. The recorded areas 1-in-a-circle to 3-in-a-circle are positioned with unrecorded areas therebetween. “SRA(*)” and “LRA(*)” denote addresses on the disk. In the recorded area 1-in-a-circle, data is recorded from address SRA (1) to address LRA (1). In the recorded area 2-in-a-circle, data is recorded from address SRA (2) to address LRA (2). In the recorded area 3-in-a-circle, data is recorded from address SRA (3) to address LRA (3).

In the recorded/unrecorded area management table, corresponding to the above-described recorded areas 1-in-a-circle to 3-in-a-circle, pairs of recording start address SRA(*) and a corresponding recording end address LRA(*) are stored. When data is recorded on the disk, the recorded/unrecorded area management table is stored on the disk at predetermined timing, thereby information on the recorded/unrecorded areas can be obtained by reading the table without actually checking the recorded/unrecorded areas.

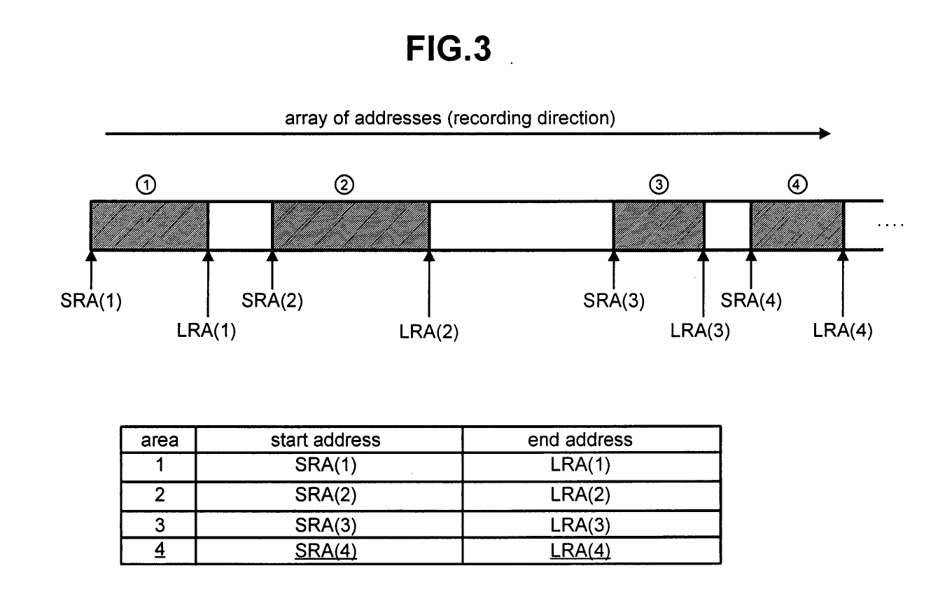

FIG. 3 illustrates a status where recording is newly made in an area 4-in-a-circle in addition to the recorded areas 1-in-a-circle to 3-in-a-circle in FIG. 2. When data is recorded in the area 4-in-a-circle, a start address SRA (4) and an end address LRA (4) are added to the recorded/unrecorded area management table. In this example, recording is made in the area 4-in-a-circle having a largest address number, however, in a case where recording is made between the recorded areas 1-in-a-circle and 2-in-a-circle, the recorded/unrecorded area management table is rearranged in ascending order of SRA, thereby the recorded area can be easily managed.

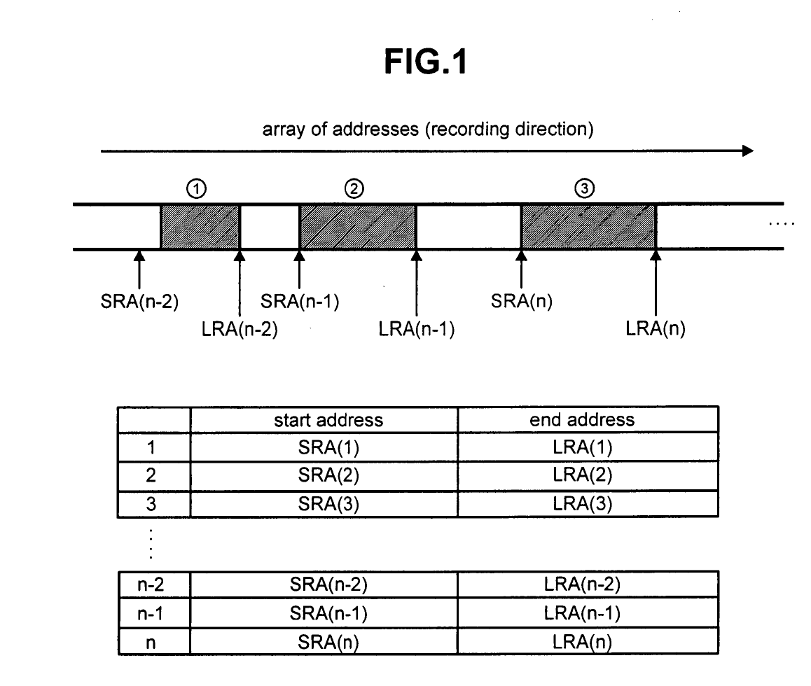

Next, FIG. 1 illustrates a status where recording is made in recording areas (n−2), (n−1) and (n). When data is recorded in the areas (n−2), (n−1) and (n), start addresses SRA (n−2), SRA (n−1) and SRA (n) and end addresses LRA (n−2), LRA (n−1) and LRA (n) are added to the recorded/unrecorded area management table. As the upper limit of the number of divided recording areas is previously determined, the size of the recorded/unrecorded area management table can be limited. Further, the size of the table can be regulated by previously determining n SRA addresses.

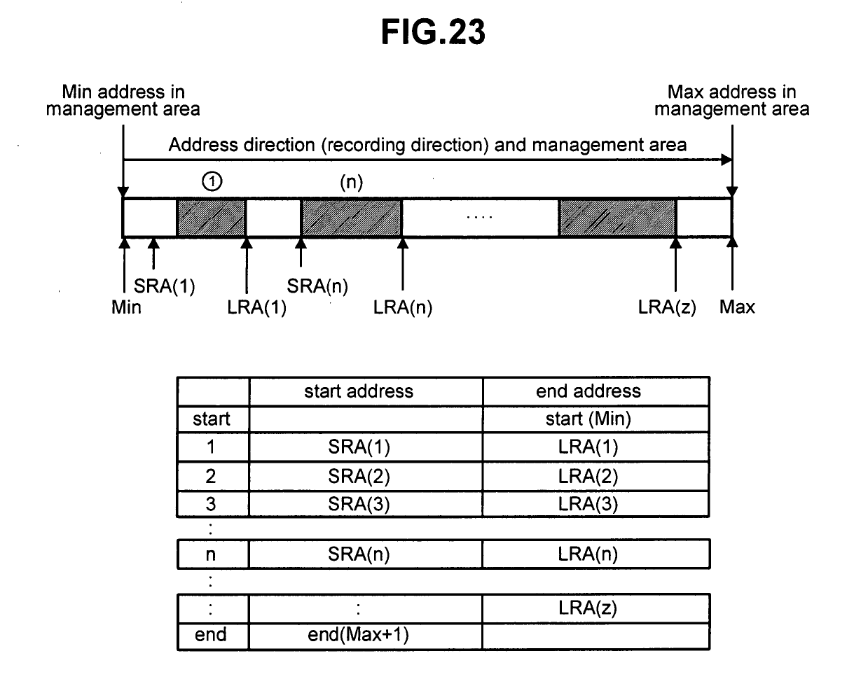

Further, as shown in FIG. 23, to indicate the head and end of the table, a minimum address (Min) in a management area where address management on the recording medium is made, and a value (Max+1), obtained by adding “1” to a maximum address (Max) in the management area, are added to the table. Further, these addresses (Min, Max+1) indicating the head and end of the table can also be utilized for detecting the size of unrecorded area between recorded areas. The size of each unrecorded area can be obtained by subtracting an end address LRA(n) of a recording area (n) from a start address SRA(n+1) of the next recording area (n+1). The sizes of unrecorded areas positioned at both ends of the management area in FIG. 23 from a recording area (1) and a recording area(z) can be respectively obtained with similar calculation to SRA(1)-Min and (Max+1)-LRA(z). It may be arranged such that (Max) is recorded as an end address, or that a head bit and an end bit indicating the head and the end are set and the start address and end address are recorded with the bits.

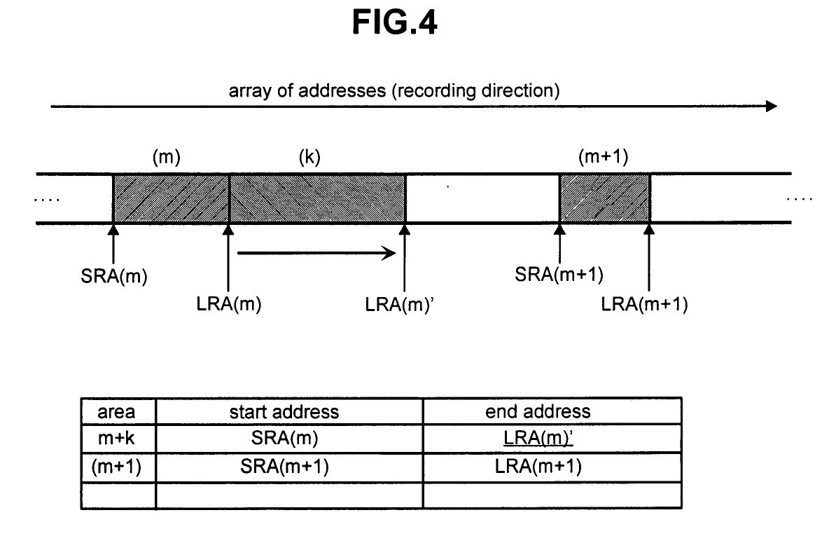

FIG. 4 illustrates a status where recording is newly made in an area (k) in addition to areas (m) and (m+1). When data is recorded in the area (k), if recording is made at an address adjacent to the area (m), i.e., the addresses LRA (m) and SRA (k) are continuous addresses, the recording area is a continuous m+k area and seemingly the address LRA (m) has moved to LRA (m)′. At this time, the start address SRA (k) of the area (k) is not added to the recorded/unrecorded area management table, but the LRA (m) is changed to LRA (m)′ as an area corresponding to the m+k area. Note that in the above description, the recorded/unrecorded area management table has an area column for the sake of explanation, however, the table does not necessarily has the area column as long as it enables discrimination between recorded and unrecorded areas. The information on an area size can be obtained by writing as LRA (*)—SRA (*).

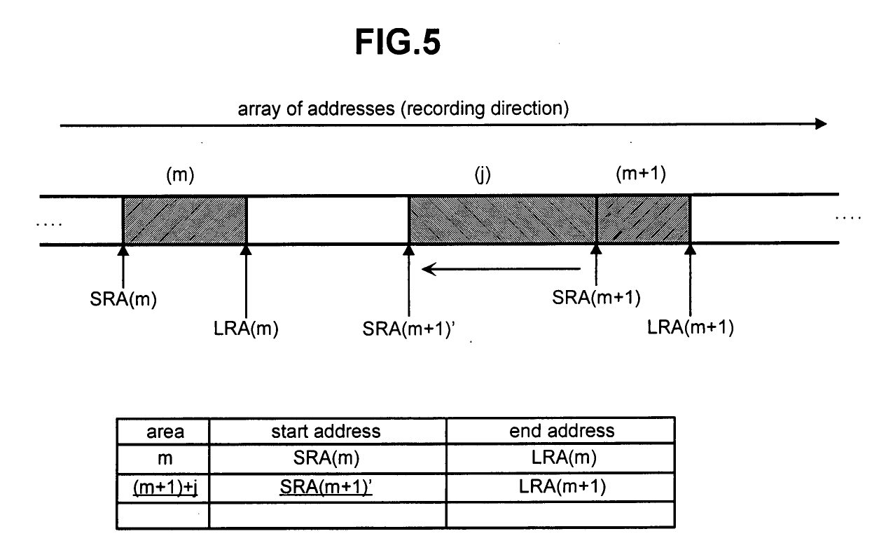

FIG. 5 illustrates a status where recording is newly made in an area (j) in addition to the areas (m) and (m+1). In this example, when data is recorded in the area (j), the data is written from a start address SRA (j) immediately before the area (m+1). That is, if addresses LRA (j) and SRA (m) become continuous addresses as a result of recording to the address LRA (j), the recorded area becomes a continuous area (m+1)+j, and seemingly the address SRA (j) has moved to SRA (m+1)′. At this time, the start address SRA (j) of the recorded area (j) is not newly added to the recorded/unrecorded area management table, but the address SRA (m+1) is changed to SRA (m+1)′ in correspondence with the area (m+1)+j. It may be arranged such that the start address SRA (j) and an end address LRA (m+1) are added as addresses corresponding to the recorded area (m+1)+j and the addresses SRA (m+1) and LRA (m+1) corresponding to the recorded area m+1 are deleted.

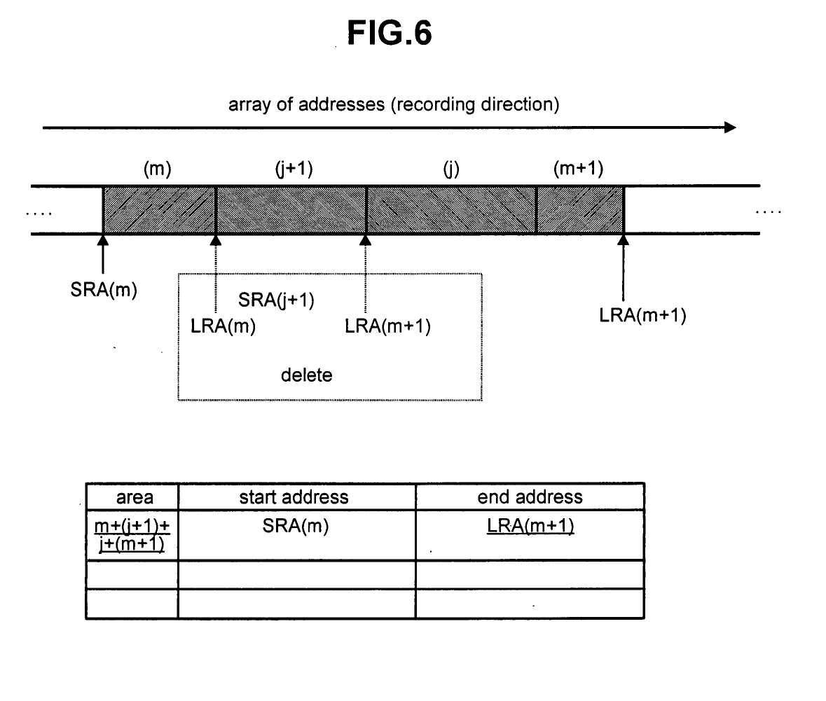

FIG. 6 illustrates a status where recording is newly made in an area (j+1) in addition to the areas (m), (j) and (m+1). In this example, when data is recorded in the area (j+1), the data is written from a start address SRA (j+1) immediately before the area j+(m+1). That is, the addresses LRA (m) and SRA (j+1) are continuous addresses, and if addresses LRA (j+1) and SRA (j+1) become continuous addresses as a result of recording, the recorded area becomes a continuous area m+(j+1)+j+(m+1). At this time, the start address SRA (j+1) of the recorded area (j) is not newly added to the recorded/unrecorded area management table, but the address SRA (m) is used in correspondence with the area m+(j+1)+j+(m+1), and an address LRA (m+1) is used as an end address. As the previously 2 areas become 1 area, present unnecessary area address information is deleted.

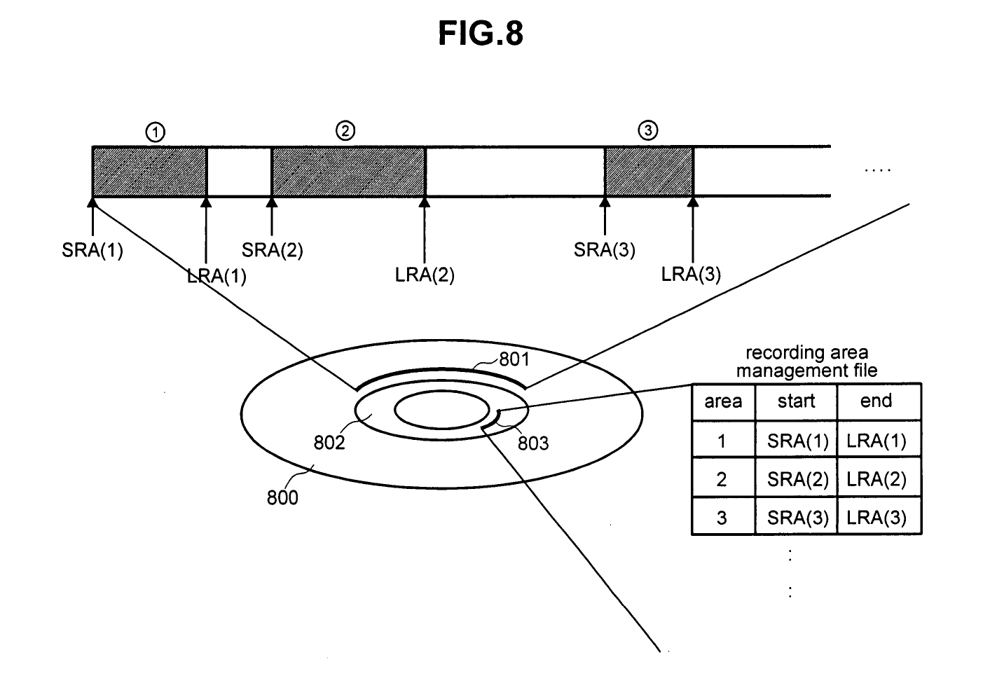

FIG. 8 illustrates an example where a data recording area and a recorded/unrecorded area management table are recorded on a write-once-read-many optical disk. A write-once-read-many optical disk 800 has a management area 802 for recording management information and a data recording area for recording user data. When data is recorded in the data area, it is recorded as indicated with numeral 801, and the recorded/unrecorded area management table is recorded in a predetermined position of the management area 802 at predetermined timing as indicated with numeral 803. To ensure reliability, the management table may be repeatedly recorded in other areas in the management area 802, or the management area may be provided further another position. If the management area becomes full, a part of the data area may be used as a management area.

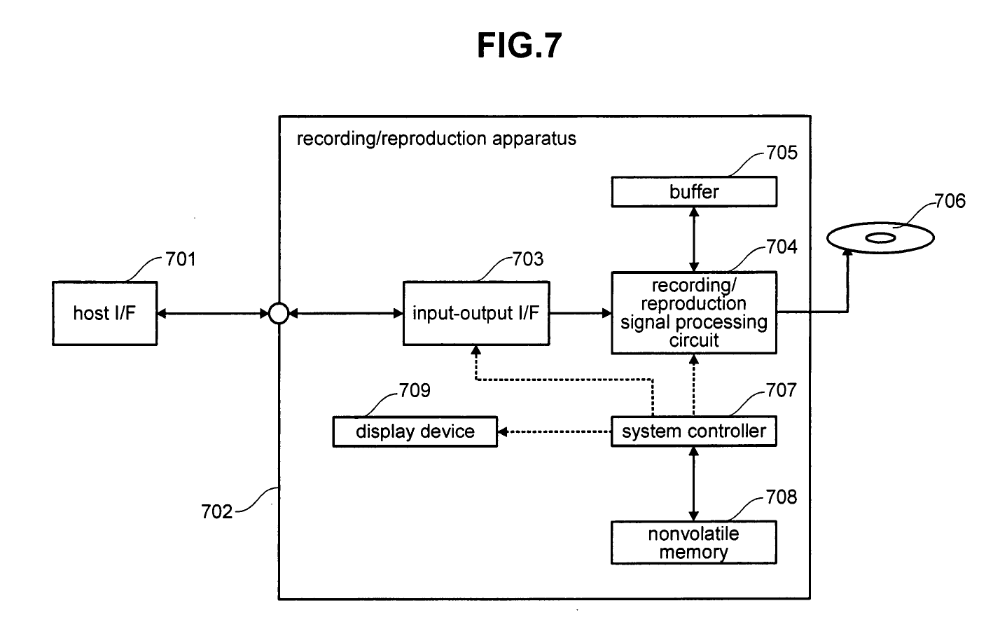

FIG. 7 is a block diagram showing an example of the construction of a system for recording and reproducing data on/from a disk. Numeral 701 denotes a host side I/F; 702, a data recording/reproduction apparatus; 703, an input-output I/F; 704, a signal processing circuit for recording/reproduction; 705, a buffer for signal processing; 706, an optical disk; 707, a system controller; 708, a nonvolatile memory; and 709, a display device.

The host I/F 701 issues a data input/output request from a PC or the like to designate a disk address for recording data in a predetermined area or to read data from a predetermined address. The input-output I/F 703 receives data for recording, outputs reproduced data, or inputs/outputs a command for control of data input/output. Upon recording, the signal processing circuit 704 adds error correction code to data in accordance with a recording format or performs modulation thereby performs encode processing. Upon reproduction, the signal processing circuit 704 performs decode processing such as demodulation and error correction. Upon signal processing, the buffer 705 may be used for temporarily storing data. Data is recorded by an optical pickup (not shown), and recorded/unrecorded areas exist on the disk 706. In a case where data is recorded, if recording regulation to perform recording from the inner circumferential position is set, the mixed recorded and unrecorded areas do not exist. Only using information indicating a final address of recorded area, it can be easily found that the inner side is a recorded area and the outer side is an unrecorded area. However, such regulation may limit operability. For example, in a rewritable optical disk where overwriting can be made plural times, if unnecessary data are deleted while necessary data are left, recordable areas are distributed at random. In a case where this system control is applied to management of the write-once-read-many disk, commonality of the system control can be achieved to a certain level, and the control can be simplified. Accordingly, even in the case of write-once-read-many optical disk, random recording and reproduction can be enabled. In this case, as management of recorded/unrecorded areas is important, the management must be improved. In discrimination of recorded/unrecorded area by detecting of whole disk area, it takes much time. Accordingly, the above-described recorded/unrecorded area management table is employed for recorded/unrecorded area discrimination without detection of whole disk area each time. Note that in a case where the recording is made in all random areas, as the size of the recorded/unrecorded area management table greatly increases, area division to a predetermined number is allowed, and when the number of divided areas becomes the predetermined number, recording is made in a continuous area. The host I/F 701 designates a logical address allocated to a user data area upon recording of data on a recording medium. When area division has been made to the predetermined number, the host I/F designates a continuous address. Otherwise, it may be arranged such that when the number of divided areas has become the predetermined number, physical addresses are converted in the recording/reproduction apparatus 702 for recording in a continuous area, from a logical address designated from the host I/F, thereby the number of divided areas does not exceed the predetermined number.

The system controller 707 controls the overall system. The system controller 707 reads the recorded/unrecorded area management table recorded on the disk 706 and stores it on the nonvolatile memory 708. The recorded/unrecorded area management table is updated on the nonvolatile memory 708, and recorded on the disk at predetermined timing. As the contents of the nonvolatile memory are not deleted when the power source is turned off, the contents of the recorded/unrecorded area management table can be held even if the power source is turned off before recording of the recorded/unrecorded area management table. The recorded/unrecorded area management table may be stored on the buffer memory 705. The recorded/unrecorded area management table may be written onto the disk every time it is updated, however, in such case, a large management area is required. Accordingly, the writing of the table onto the disk is made only upon disk ejection, and in a case where the table is updated, the nonvolatile memory 708 is rewritten, thereby the number of writings onto the disk can be reduced. Further, in a case where the recorded/unrecorded area management table is stored on the buffer memory 705 in normal times and the nonvolatile memory 708 is used only when the table is updated, the number of rewriting of the nonvolatile memory can be reduced.

Note that an update flag indicating whether or not the latest recorded/unrecorded area management table has been recorded on the disk is stored in the nonvolatile memory, thereby it can be determined whether or not the recorded/unrecorded area management table on the disk is the latest table. In the update flag, if a flag bit is set when even a part of the contents of the recorded/unrecorded area management table has been changed and the flag bit is reset when recording of the table on the disk has been completed, it can be easily determined whether or not the latest table has been recorded. Further, if a disk identification sign for identification of disk by 1 disk is simultaneously recorded with the update flag, in a case where the power source is turned off while the update flag is set and then another disk is inserted, it can be recognized in advance that the recorded/unrecorded area management table is different. In such case, the information indicating that the disk is different is displayed on the display device 709, otherwise, the disk identification sign of the disk that was inserted before the power-off is displayed, and thereby the user can insert the proper disk. The disk identification sign may be a disk ID recorded on the disk upon manufacturing or may be a disk identification number arbitrarily assigned by the recording/reproduction apparatus 702 or the like.

The display device 709 is provided in the recording/reproduction apparatus 702 here, however, the present invention is not limited to this arrangement. For example, in a case where the display device is provided on the host PC side, the host PC side can appropriately perform display or the like by sending a signal indicating that the disk is different to the host I/F 701.

Further, as the timing of recording of the recorded/unrecorded area management table on the disk, for example, when the disk is taken out or the power source is turned off, the latest information is recorded, and in addition, when the contents of the recorded/unrecorded area management table have been changed, i.e., the update flag is set, the contents of the table are recorded on the disk. Note that as frequent recording causes shortage of area for recording management information, when the contents of the recorded/unrecorded area management table have not been changed, new recording is not performed. Further, by repeatedly recording the recorded/unrecorded area management table in different areas, the reliability of the table can be increased. Further, as a finalizing operation to disable further writing, the recorded/unrecorded area management table may be written in a predetermined position.

Further, the update flag may be written immediately before the writing of the recorded/unrecorded area management table on the disk. In this case, the flag bit is reset after the writing on the disk, and if any abnormality such that power-off or the like occurs in the middle of writing of the recorded/unrecorded area management table, the occurrence of abnormality can be found from the state of the update flag. Under this update flag setting condition, in a case where the power has been turned off before the update flag is set even though the recorded/unrecorded area management table was updated, the contents of the recorded/unrecorded area management table and the contents stored on the nonvolatile memory do not correspond with each other. In this case, when the power source is turned on, it is determined that an abnormality has occurred before the update of the recorded/unrecorded area management table, and the contents of the recorded/unrecorded area management table stored on the nonvolatile memory are recorded on the disk.

Under this control, when a new disk has been inserted, the recorded/unrecorded areas can be detected by reading the recorded/unrecorded area management table without detection of the entire disk area.

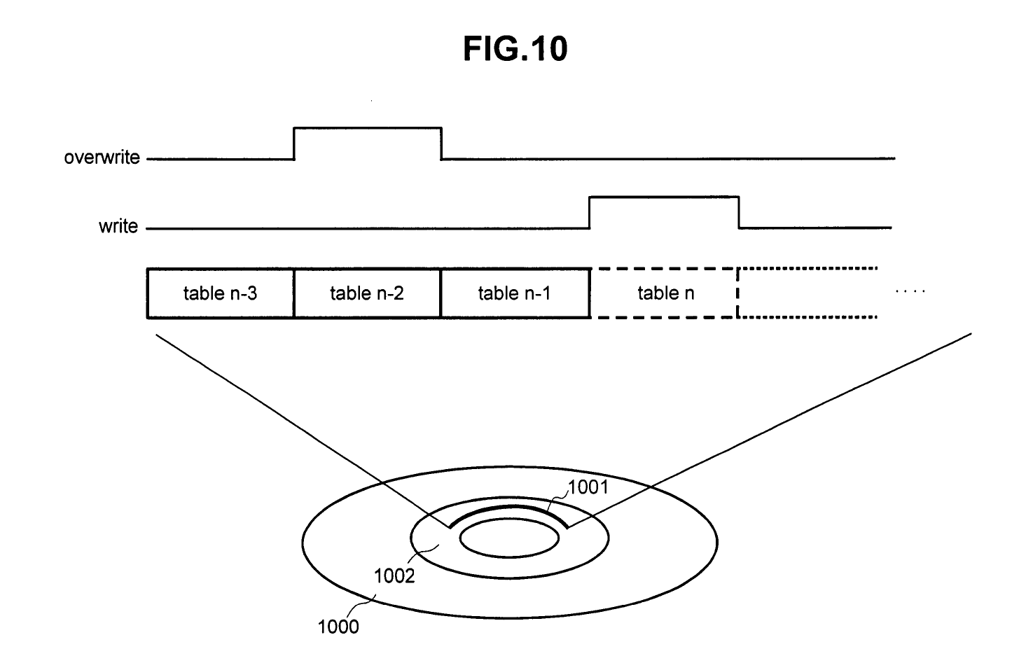

FIG. 10 illustrates an example where determination of updated/unupdated state can be made by generating error data in recorded data by overwriting or the like to disable reproduction, without using the above-described update flag. A recorded/unrecorded area management table 1001 is recorded in a management area 1002 on a disk 1000. The recorded/unrecorded area management table is updated at predetermined timing, and tables n−3, n−2, n−1, . . . are held in descending order from the oldest table. In a write-once-read-many recording disk, if recorded data is irradiated with laser, i.e., overwritten, the characteristic of the recording film is changed and the data is destroyed, and the initially written data cannot be correctly read out. Accordingly, when a disk is newly inserted, the recorded/unrecorded area management table n−2 is overwritten and the data is destroyed instead of using the update flag, thereby the update of the table is indicated. When the recorded/unrecorded area management table is newly updated, a recorded/unrecorded area management table n is recorded. The new recorded/unrecorded area management table n−1 is left since there is a possibility of use of the table. The overwriting is performed not upon disk insertion but upon update of recorded/unrecorded area management table. First, the recorded/unrecorded area management table n−2 is overwritten, and if the recorded/unrecorded area management table n has been correctly recorded to the end, the completion of writing of the recorded/unrecorded area management table is indicated. By this arrangement, it can be detected that the recorded/unrecorded area management table has been normally written without using the above-described update flag.

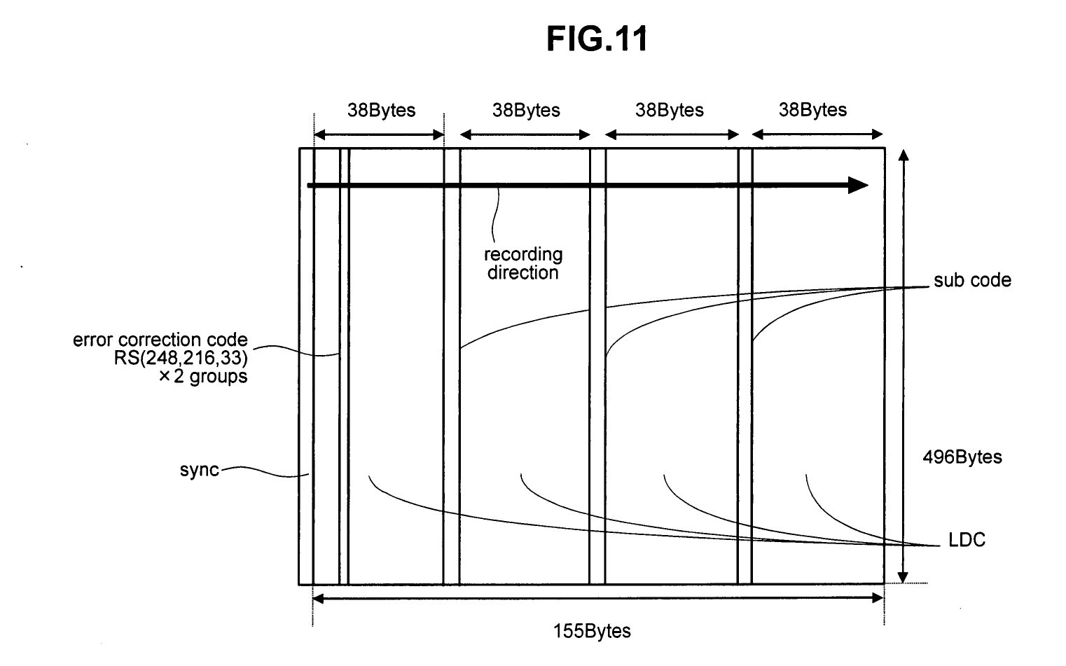

FIG. 11 illustrates a block structure of recorded data described in “Optical Disc System for Digital Video Recording” (Jpn. J. Appl. Phys. Vol. 39(2000) Pt. 1, No. 2B FIG. 2).

The user data is encoded by 64 Kbytes, as a 496×155 byte data including LDC (Long Distance Code), address information called BIS (Burst Indicator Sub code) and sub code. The data is recorded on the recording medium in a direction indicated with a bold arrow. For example, the recorded/unrecorded area management table in this data structure is recorded on the disk.

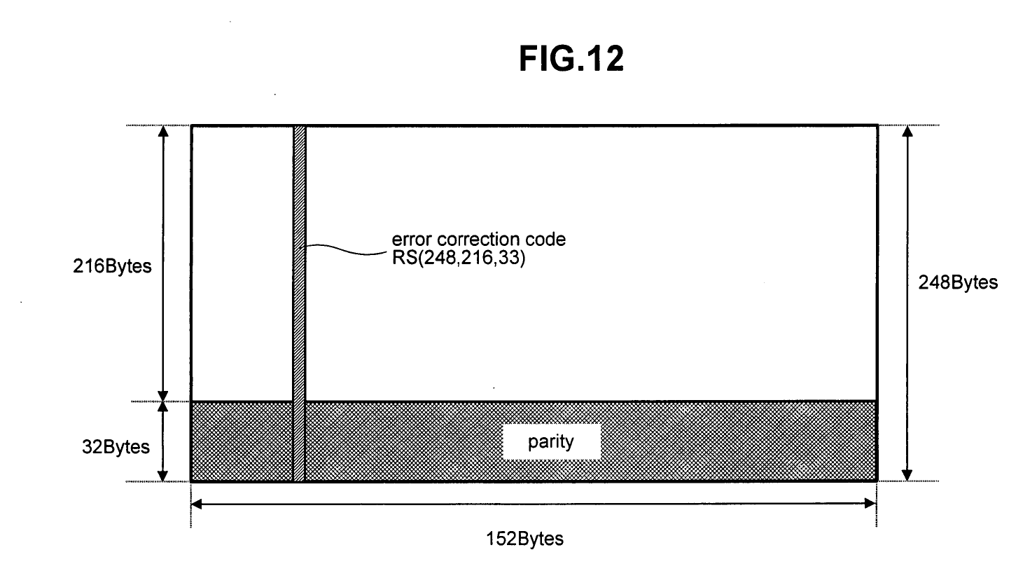

As shown in FIG. 12, the LDC coding has a 248×152 byte data structure including 216 data by RS (Reed-Solomon) code with 32 parities. LDC data has 2 of the above data structure.

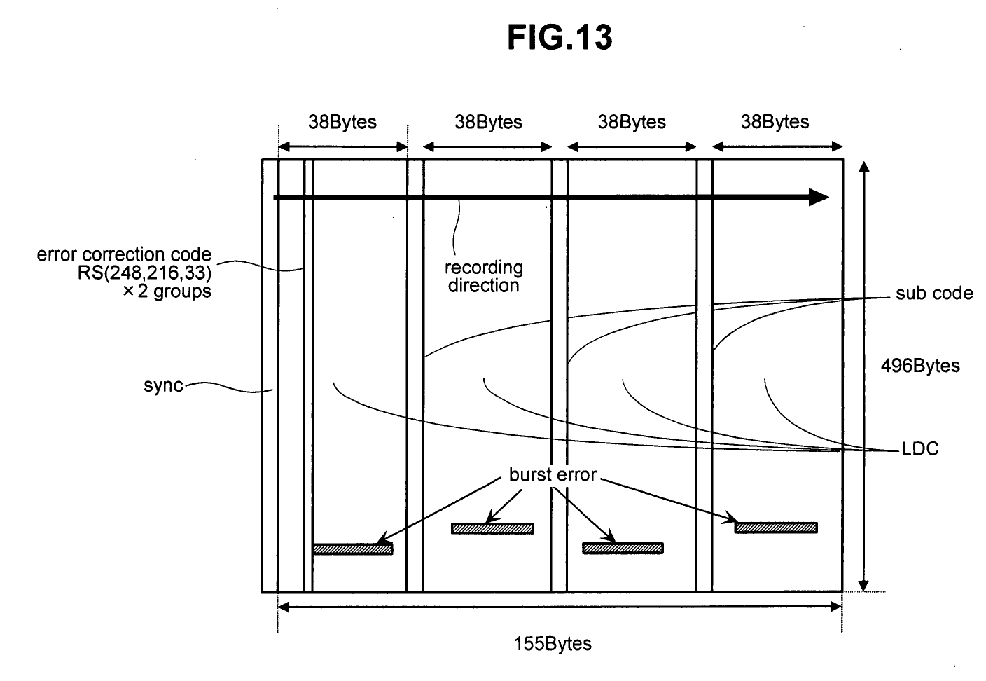

FIG. 13 illustrates an example where a particular burst error is generated by overwriting in the recorded data block structure in FIG. 11. In the figure, hatched portions indicate burst errors. If the error position is previously determined, a naturally-caused error and the error caused by overwriting can be discriminated from each other. In the present embodiment, the burst errors are generated in 4 positions, however, the burst length and the number of errors are not limited to the above case. In particular, regarding the burst length, if a burst error is longer than the longest continuous pattern generated in modulation rule used in this system, it can be easily recognized as an error pattern.

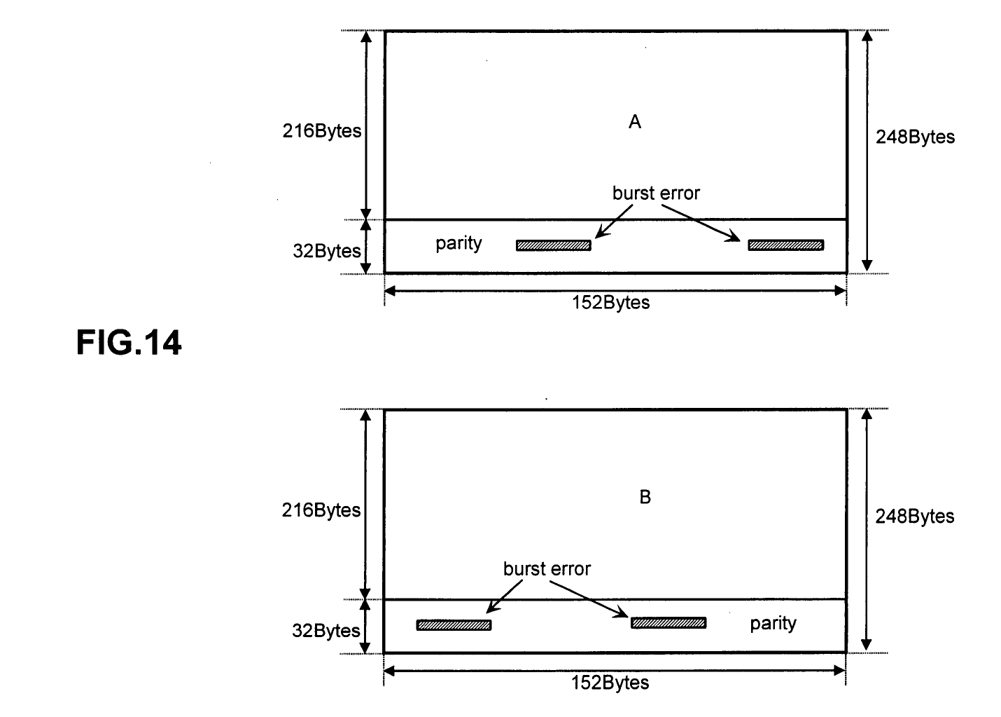

FIG. 14 illustrates the burst errors in FIG. 13 in the structure of LDC code in FIG. 12. If a particular error is caused by overwriting in the respective LDCs A and B, concentration of burst errors in one of the LDCs can be prevented. In this manner, as the errors are distributed, the error positions can be accurately detected, and the error positions are detected as particular errors having the same role of the update flag. Further, as the error is caused in the parity portion, the actually used data portion is not impaired.

In the RS code, since up to 16 error positions can be independently detected, if there is no other error, up to 16 errors may be caused in one line (in vertical direction). Accordingly, it may be arranged such that a particular error position is detected by a combination of several error positions. Further, in the present embodiment, the burst error as a continuous error is caused, however, a single error or plural errors may be caused.

Further, even if updating using the update flag is not performed, as brief recorded/unrecorded area information can be obtained, recorded/unrecorded discrimination may be made by accessing the brief information. In such case, time for discrimination can be reduced in comparison with detection of the whole disk area.

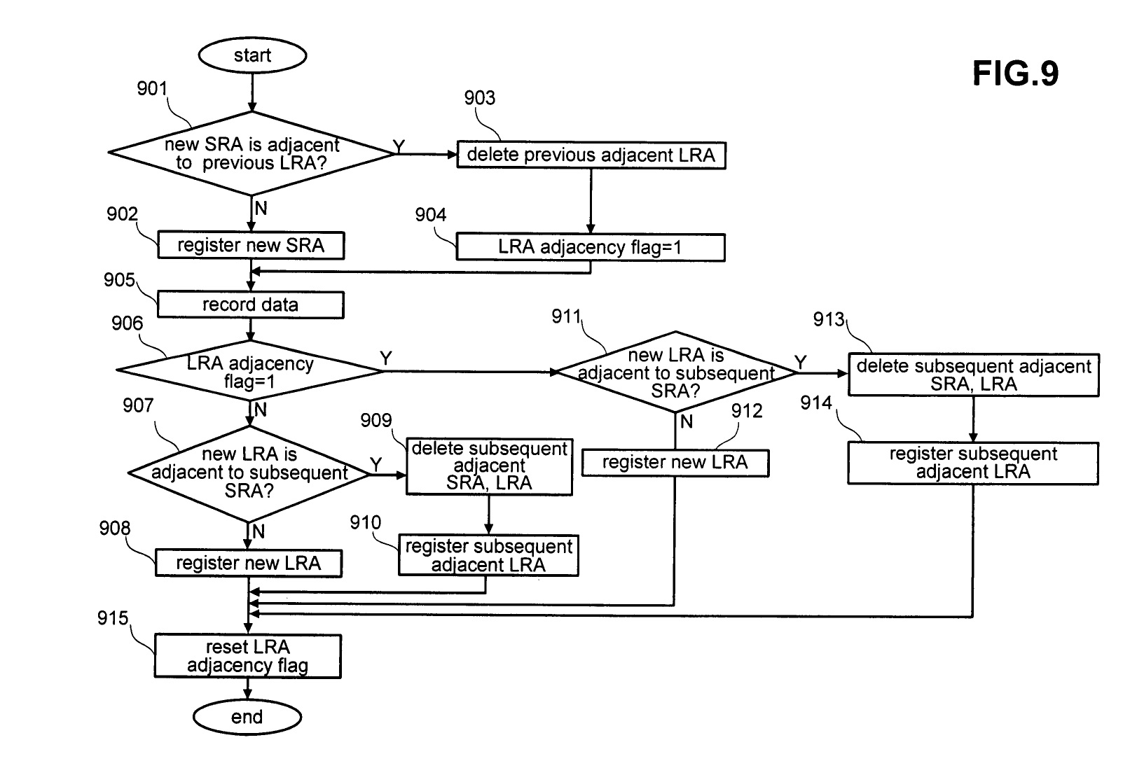

FIG. 9 is a flowchart showing processing upon update of the contents of the recorded/unrecorded area management table. Especially in this case, the contents of the recorded/unrecorded area management table is updated when the number of divided areas has not become a predetermined number N. When data is newly recorded on a disk, the system controller designates a recording start address. At step 901, it is determined whether or not the new SRA as the start address of the data is adjacent to any LRA in already-recorded area. If the new SRA is not adjacent to any LRA of recorded area, the new SRA is registered in the recorded/unrecorded area management table at step 902. If there is an adjacent LRA, recording is started immediately after the recorded area. At step 903, the previous adjacent LRA is deleted, and an LRA adjacency flag is set to “1” at step 904. Any one of the deletion of the LRA at step 903 and the flag setting at step 904 may be performed first. Then at step 905, the data is recorded.

At step 906, first, it is determined whether or not the adjacency flag is “1”. If the flag is “0”, the process proceeds to step 907. At step 907, it is determined whether or not the new LRA as the end address of the data is adjacent to any SRA of already-recorded area. If the new LRA is not adjacent to any SRA of recorded area, the new LRA is registered in the recorded/unrecorded area management table at step 908. Note that in a case where the process moves through this path, recording is made in an area positioned between previous and subsequent unrecorded areas as shown in FIG. 3.

If there is an adjacent SRA, as the recording end position is connected to the recorded area, the addresses SRA and LRA of the subsequent adjacent area are deleted at step 909, then the deleted LRA of the subsequent adjacent area is registered as an LRA corresponding to the new recording area. Any one of the deletion of the addresses at step 909 and the registration at step 910 may be performed first. Note that in a case where the process moves through this path, recording is made in an area connected to a subsequent recorded area as shown in FIG. 5.

At step 906, if the adjacency flag is “1”, the process proceeds to step 911. At step 911, as in the case of step 907, it is determined whether or not the new LRA as the end address of the data is adjacent to any SRA of already-recorded area. If the new LRA is not adjacent to any SRA of recorded area, the new LRA is registered in the recorded/unrecorded area management table at step 912. Note that in a case where the process moves through this path, recording is made in an area connected to a previous recorded area as shown in FIG. 4.

If there is an adjacent SRA, as the recording end position is connected to the recorded area, the addresses SRA and LRA of the subsequent adjacent area are deleted at step 913, then the deleted LRA of the subsequent adjacent area is registered as an LRA corresponding to the new recording area at step 914. Any one of the deletion of the addresses at step 913 and the registration at step 914 may be performed first. Note that in a case where the process moves through this path, recording is made in an area connected to previous and subsequent recorded areas as shown in FIG. 6. Through these paths, the adjacency flag is reset at step 915, and the recording is completed.

In a case where the number of recorded areas is equal to or greater than n, as recording cannot be made in a new independent area, recording is performed such that a recording area is connected to any of previous or subsequent recorded area.

By this processing, the address information of the recorded/unrecorded area management table can be updated.

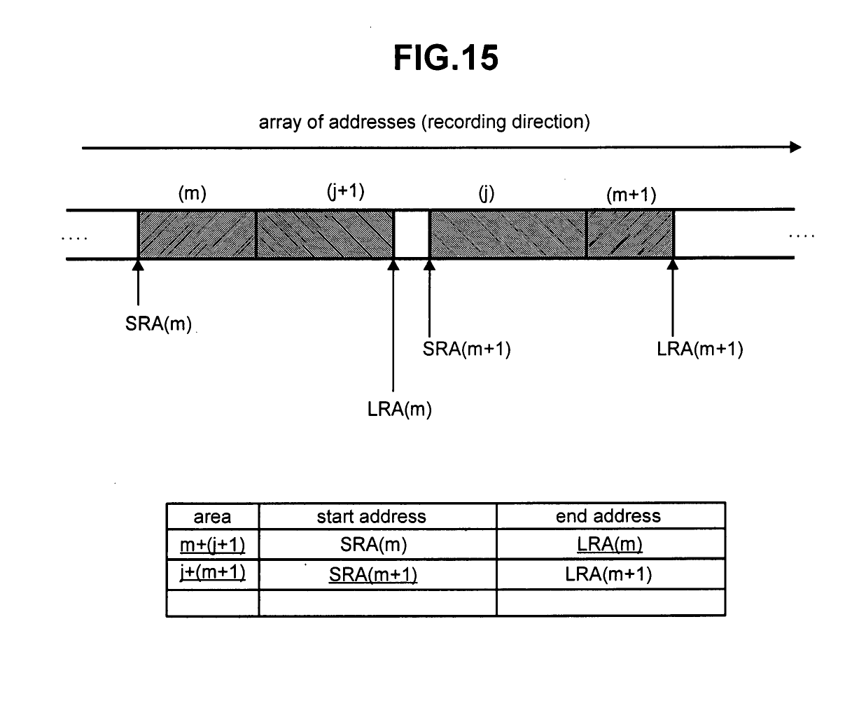

Next, FIG. 15 illustrates a status where a gap remains, as a result of recording in an area connected to a previous recorded area as shown in FIG. 4 and recording in an area connected to a subsequent recorded area as shown in FIG. 5, different from an area connected to previous and subsequent recorded areas as shown in FIG. 6. In this case, as the unrecorded area remains between the 2 recorded areas is very small, it is difficult to detect the unrecorded area by scanning. Accordingly, a method for inserting an identification signal into a part of additionally recorded data for detection of small unrecorded area will be described.

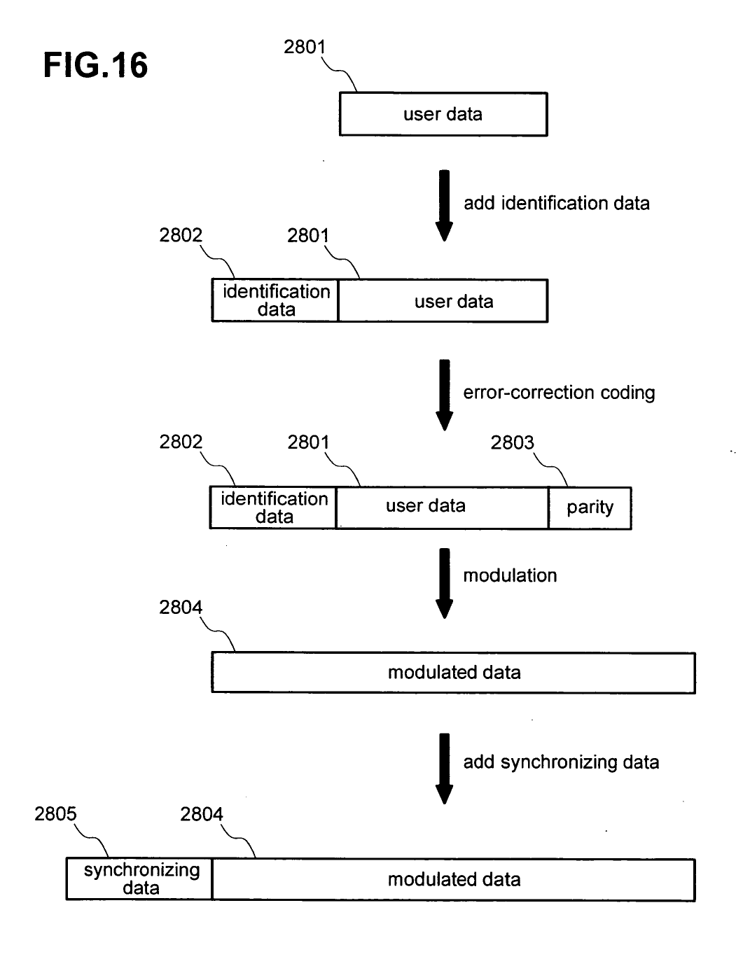

FIG. 16 illustrates an example of the flow of processing to encode recording data. The flow of the processing is applicable to the recording block structure as shown in FIG. 11. Identification data 2802 is added to user data 2801 and a parity 2803 is added to the data, thereby error correction coding is performed. The error-correction encoded data is subjected to modulation, as modulated data 2804, then synchronizing data 2805 is added to the modulated data, into a data form for recording on a recording medium.

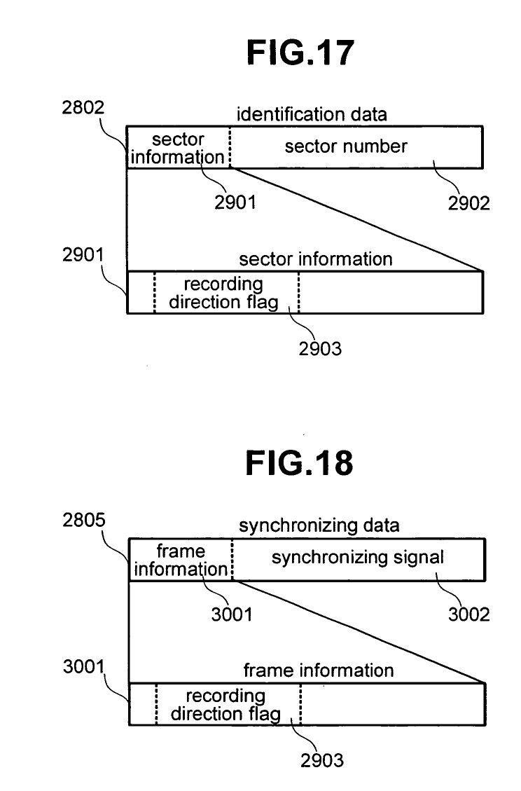

FIG. 17 illustrates an example where a signal for recording direction identification is included in a part of the identification data 2802. The identification data 2802 has sector information 2901 and a sector number 2902. The sector information 2901 includes additional information on the sector. The sector number 2902 includes information corresponding to an address indicating a physical position on the recording medium. A recording direction flag 2903, indicating a recording direction, is included in the sector information 2901. The recording direction flag 2903 indicates, in a case where recording is made in an area adjacent to an already-recorded area, that recording is made in an area to be connected to a previous recorded area as shown in FIG. 4, or that recording is made in an area to be connected to a subsequent recorded area as shown in FIG. 5. By using this flag, even in a case where the recorded/unrecorded area management table is not updated upon each recording, a recorded area and its direction after recording of the recorded/unrecorded area management table can be detected. Further, even if a small unrecorded area remains between 2 areas, the small area can be detected by using this recording direction flag. The identification data 2802 corresponds to the sub code in FIG. 11.

FIG. 18 illustrates an example where the recording direction flag shown in FIG. 17 is included in the synchronizing data. Synchronizing data 2805 has frame information 3001 and a synchronizing signal 3002. The frame information 3001 includes additional information on the frame. The synchronizing signal 3002 is a timing signal to obtain the unit of data decoding. As in the case of FIG. 17, even if a small unrecorded area remains between 2 areas, the small area can be detected by including the recording direction flag 2903 in the frame information 3001.

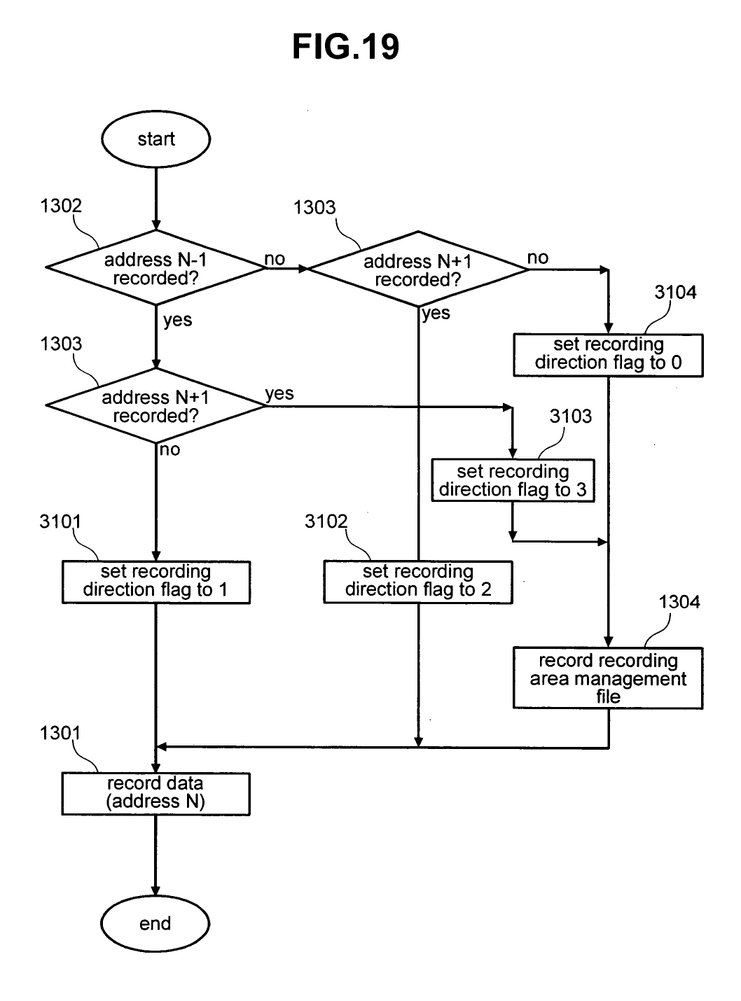

FIG. 19 is a flowchart showing an example of the flow of processing to set a recording direction flag upon data recording. Upon recording, at step 1302, it is determined whether or not an address N−1 with respect to an address of current recording is a recorded area address. Next, at step 1303, it is determined whether or not an address N+1 is a recorded area address. By the determination at steps 1302 and 1303, recording in an address decremental direction or recording in an address incremental direction can be discriminated. In the case of recording in an address incremental direction, the recording direction flag is set to 1 at step 3101, while in the case of recording in an address decremental direction, the recording direction flag is set to 2 at step 3102. In a case where there is no adjacent recorded area, as the addresses N−1 and N+1 are not recorded area addresses, the recording direction flag is set to 0 at step 3104. In a case where the addresses N−1 and N+1 are recorded area addresses, as one of the address is filled thereby 2 areas are connected, the recording direction flag is set to 3 at step 3103. At this time, the recording direction flag may be set to 1 or 2. In a case where the recording direction flag is 0 or 3, as recording is made in a new area or areas are connected, the recorded/unrecorded area management table is updated at step 1304. The flag is added to the data and it is recorded on the recording medium 1301. Note that upon general recording, as the address is in an incremental direction, the same flag may be used as the recording direction flags 1, 0 and 3. Further, it may be arranged such that the flag is not set in the case of the recording direction flags 1, 0 and 3, while a flag bit is set only in the case of the recording direction flag 2 in the case where the address is in a decremental direction. By setting this recording direction flag, even in scanning recorded/unrecorded areas of the recording medium, a recording direction of a target address can be obtained, and an unrecorded area can be detected.

In the present embodiment, the recording medium is a write-once-read-many optical disk, however, the present invention is not limited to this type of disk but there is no particular limitation on the recording medium as long as recording is performed on a recordable medium. Further, a data recording address is designated from a drive, however, similar control can be performed by an operation in accordance with an instruction from the host I/F.

As described above, according to the present invention, upon recording of data on a write-once-read-many disk, recorded/unrecorded areas can be detected without detection of the whole disk area, and time for management can be reduced. Further, as the recorded/unrecorded area management table is stored on a nonvolatile memory and a flag indicating that updated information has been recorded on the disk is added, even if an abnormality such as power-off has occurred, it can be determined that the recorded/unrecorded area management table recorded on the disk is proper table. Further, the information similar to the flag can be provided by causing an error in a particular position by overwriting on recorded data.

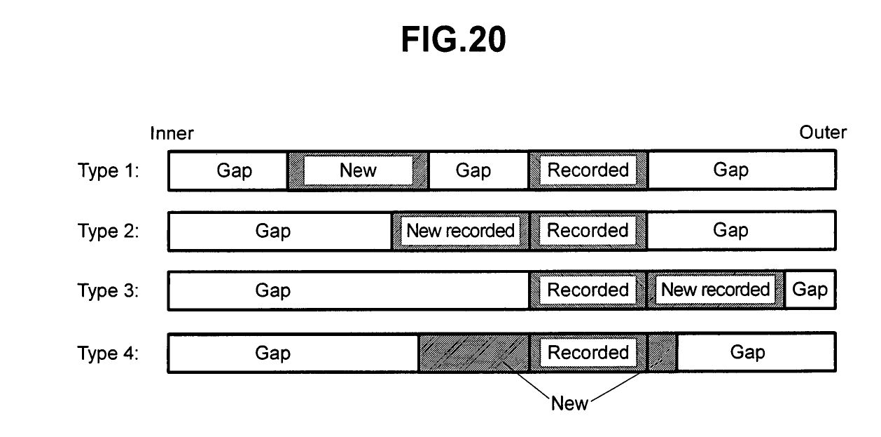

FIG. 20 illustrates the types of location of new recorded area with respect to a previous recorded area when data is newly recorded. In this embodiment, different from the above-described example, the direction of recording is always rightward (address incremental direction). In this figure, the left side is the inner peripheral side (smaller address side) and the right side is the outer peripheral side (larger address side).

In the case of “type 1”, recording is made in a new recording area without contact with a recorded area. In the case of “type 2”, recording is made in a new recording area with a right end as the end of recording is in contact with a recorded area. In the case of_“type 3”, recording is made in a new recording area with a left end as the start of the recording is in contact with a recorded area. In the case of “type 4”, recording is made in new recording areas holding a recorded area therebetween.

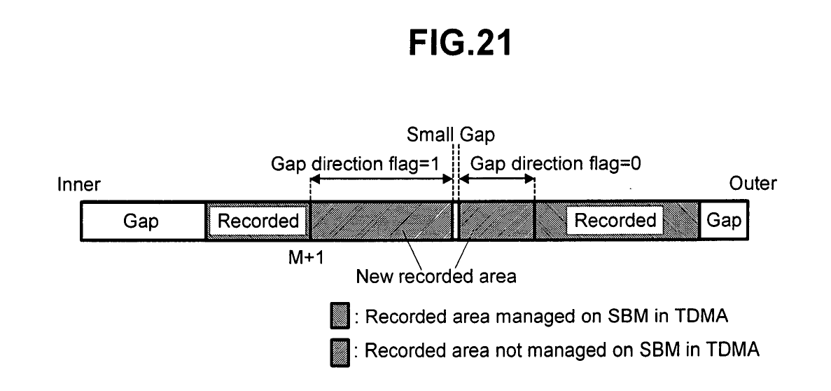

FIG. 21 illustrates an example where an unrecorded area remains upon data recording. For example, in a case where recording is newly made in an unrecorded area (Gap) between 2 recorded areas as in the case of “type 2” and “type 3” in FIG. 20, a small unrecorded area occasionally remains. Such a small unrecorded area cannot be detected by scanning without difficulty. Accordingly, a Gap retrieval flag is added for retrieval of small unrecorded area, such that the direction where a small unrecorded area remains can be easily found. Note that the recorded/unrecorded area management table is updated when the number of unrecorded areas has changed. When recording is made so as to fill a Gap between 2 recorded areas, or when recording is newly made in the middle of an unrecorded area and a new Gap is generated as in the case of “type 1” in FIG. 21, the number of unrecorded areas changes. However, in a case where the number of unrecorded areas does not change even upon new recording, as the recorded/unrecorded area management table is not updated, it is necessary to detect a remaining unrecorded area. At this time, the above Gap retrieval flag is utilized.

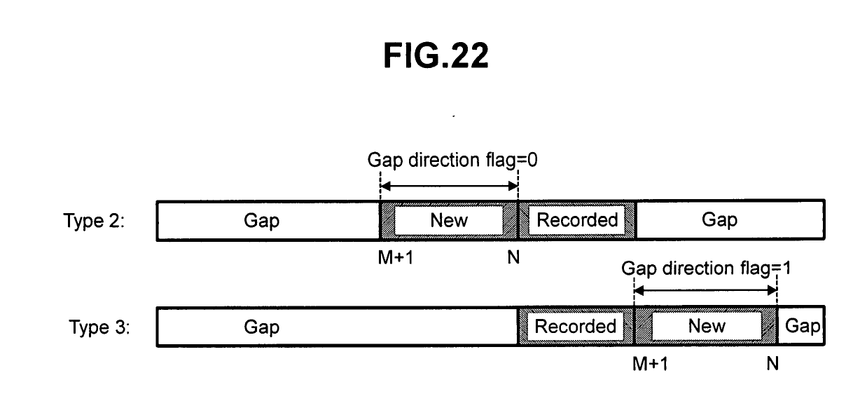

FIG. 22 illustrates an example of setting of a Gap retrieval flag upon new data recording for detection of a small unrecorded area as shown in FIG. 21. When data is newly recorded in an unrecorded area, if a left adjacent address n−1 of a recording start address n is an unrecorded area address, the Gap retrieval flag is set to “0” and recording is made. Then, if recording is continuously made, the address is incremented as n+1, n+2, . . . with the same Gap retrieval flag. If the recording is continued to a recorded area, no unrecorded area remains. As the same Gap retrieval flag is added by continuously-made recording, retrieval can be made by a series of data recording.

Further, if the left adjacent address n−1 of the recording start address n is a recorded area address, the Gap retrieval flag 1 is set to “1” and recording is made. In a case where this flag is added, if the Gap retrieval flag is “0”, there is a possibility that the left adjacent area of the recording area is an unrecorded area, while if the Gap retrieval flag is “1”, there is a possibility that the right adjacent area is an unrecorded area. If the Gap retrieval flags 1 and 0 are continuous (adjacent), no unrecorded area exists therebetween. Accordingly, an unrecorded area can be retrieved by retrieving a connection point between the Gap retrieval flags 1 and 0.

Note that as an area, which has become a recorded area upon new recording, and to which a Gap retrieval flag is added, the area of recording direction flag as shown in FIGS. 17 and 18 may be used.

In the present embodiment, an optical disk is used as the recording medium, however, the present invention is not limited to the optical disk, but there is no particular limitation on the recording medium as long as recording is performed on once-recordable medium. Further, a data recording address is designated from a drive, however, similar control can be performed by an operation in accordance with an instruction from the host I/F.

The foregoing invention has been described in terms of preferred embodiments. However, those skilled, in the art will recognize that many variations of such embodiments exist. Such variations are intended to be within the scope of the present invention and the appended claims.

1. An information recording method for recording data on a write-once recording medium, comprising the steps of:
recording information corresponding to a position of a recorded area of the recording medium, on the recording medium, and
when the information corresponding to the position of the recorded area is updated, newly recording the information on the recording medium at a predetermined timing.

2. The information recording method according to claim 1, wherein:
the recorded information corresponding to the position of the recorded area comprises information on a predetermined number of areas, and
the recorded areas are recorded as discrete areas with the predetermined number as a limitation.

3. The information recording method according to claim 1, wherein the information comprises physical address information on the recording medium, recorded as a recording start address and a recording end address.

4. A recording apparatus, having a pickup, a signal processing circuit for signal processing accompanying recording and an interface for data input and output, for recording data on a write-once recording medium, wherein:
information corresponding to a position of a recorded area on the recording medium is read from the recording medium by the pickup, and
the information corresponding to the position of the recorded area is stored on a nonvolatile memory.

5. The recording apparatus according to claim 4, wherein:
when the information corresponding to the position of the recorded area is updated, an update flag indicating that the information has been updated is set in the nonvolatile memory and the information corresponding to the position of the recorded area is recorded on the recording medium at predetermined timing; and
when recoding is completed, the update flag is reset.

6. A recording apparatus, having a pickup, a signal processing circuit for signal processing accompanying recording and an interface for data input and output, for recording data on a write-once-read-many recording medium, wherein:
information corresponding to a position of a recorded area on the recording medium is read from the recording medium by the pickup, and
when the information corresponding to the position of the recorded area is updated, error data is generated in a particular position indicating that the information has been updated.

7. The recording apparatus according to claim 6, wherein as the error data in the particular position comprises error data in a particular portion of the information corresponding to a position of a recorded area previous by twice of recording on the recording medium.

8. An information recording method for recording data on a write-once recording medium, comprising the steps of:
recording information corresponding to a position of a recorded area of the recording medium on the recording medium, and
when the information corresponding to the position of the recorded area is updated, newly recording the information on the recording medium at a predetermined timing,
wherein when data is additionally recorded on the recording medium, a recording direction flag is included in the data indicating an address of recording is in an incremental direction or in a decremental direction.

9. The information recording method according to claim 8, wherein the recording direction flag is included in a sector identification signal added in a sector unit to the data.

10. The information recording method according to claim 8, wherein:
the data corresponds to at least two types of synchronizing signals, and
the recording direction flag corresponds to the synchronizing signals of the data.

11. An information recording method for recording data on a write-once recording medium, comprising the steps of:
recording information corresponding to a position of a recorded area on the recording medium of the recording medium, and
when the information corresponding to the position of the recorded area is updated, newly recording the information on the recording medium at a predetermined timing,
wherein when data is additionally recorded on the recording medium, a retrieval flag in the data indicates whether or not an area with an address smaller than that of recording start area by 1 is a recorded area.

12. The information recording method according to claim 11, wherein the retrieval flag is included in a sector identification signal added in a sector unit to the data.

13. The information recording method according to claim 11, wherein:
the data corresponds to at least two types of synchronizing signals, and
the retrieval flag corresponds to the synchronizing signals of the data.

14. The information recording method according to claim 11, wherein the same retrieval flag is added by a series of recording of the data.

15. The information recording method according to claim 1, wherein the information includes information corresponding to a start address or an end address of a management area on the recording medium.

16. A recorded data product containing recorded data, comprising:
a write-once recording medium;
a data area on the recording medium bearing first recorded data at a first location on the recording medium and subsequently recorded data at a second location on the recording medium; and
a recording of updated management information on the recording medium, the updated management information including data identifying at least the first location and the second location.

17. The data product of claim 16, wherein:
the recording of updated management information comprises a table of addresses recorded in a predetermined portion of the recording medium, and
the addresses on the table identify the first and second locations on the recording medium.

18. The data product of claim 16, further comprising a recording direction flag in the data area on the recording medium, the recording direction flag indicating incremental or decremental change in addressing of data recorded in a portion of the data area.

19. The data product of claim 16, further comprising a retrieval flag in the data area on the recording medium, the retrieval flag indicating whether a portion of the data area has been recorded.

20. The data product of claim 16, further comprising an error signal recorded in a particular position on the recording medium indicating that the management information is updated information.

21. The data product as in claim 16, wherein the write-once recording medium comprises a write-once-read-many optical disk.
